(19) United States
(12) Patent Application Publication
(10) Pub. No.: US 2018/0355645 A1
(43) Pub. Date: Dec. 13, 2018

(54) A BOLT ASSEMBLY FOR A DEADBOLT LOCK ARRANGEMENT AND A METHOD OF OPERATION THEREOF

(71) Applicant: Trio Hinging Australia Pty Ltd, Kilburn, South Australia (AU)

(72) Inventors: Eddie Laverty, Kilburn (AU); Colin Horton, Kilburn (AU); Anaru Terei, Kilburn (AU)

(21) Appl. No.: 15/778,507

(22) PCT Filed: Nov. 9, 2016
(86) PCT No.: PCT/AU2016/000375

§ 371 Date: May 23, 2018

(30) Foreign Application Priority Data
Nov. 23, 2015 (AU) 2015904822

(51) Int. Cl. E05C 1/06; E05B 15/00; E05B 17/20; E05B 63/00

(52) U.S. Cl. CPC E05C 1/06; E05B 15/0086; E05B 63/0052; E05B 63/0017; E05B 17/2003; E05B 17/2088

(57) ABSTRACT

A bolt assembly for a deadbolt lock arrangement including a drivable cam in rotational engagement with a follower wheel. A bolt connecting arm pivotally connected to a bolt slidably supported within a main housing body of the bolt assembly and also connected to a follower wheel connecting arm that is connected to the follower wheel, wherein rotation of the drive cam translates to rotational movement of the follower wheel and rotational movement of the follower wheel translates to an extending or retracting positioning of the follower wheel connecting arm so as to extend or retract said bolt connecting arm to an extended position or retracted position thereby placing the bolt in a locked or unlocked configuration.

### FIELD OF THE INVENTION

This invention relates to a bolt assembly for a deadbolt lock arrangement and more particularly to a bolt assembly uniquely assembled and operative so when actuated will position the bolt within the corresponding recess of the door frame to an improved security with reliability and consistency in ongoing use

### BACKGROUND ART DISCUSSION

Deadbolt lock arrangements utilise a bolt assembly wherein when actuated or intended to be in the locked position the bolt should be securably positioned within a defined recess of the door frame so as to prevent the locked door from opening. A characteristic of a deadbolt lock arrangement is that the bolt once extended and received within the recess of the doorframe to prevent opening of the door should not be able to be retracted unless through authorised key entry with the rotation of either an internal or external key cylinder with a key.

In order to establish a bolt assembly to work with the distinct locking mechanism associated with a deadbolt lock arrangement it is important that any operational action of the bolt is optimised by the structural features and componentry of the bolt assembly.

Accordingly any structural activity responsible for the actuation of the bolt to be placed within its extended position within the recess defined within the doorframe should be designed with minimal operational rotational requirements and also structural integrity between the respective structural features and components for consistent, secure and reliable deadbolt locking of the door once the mechanism of the deadbolt lock arrangement is actuated.

As introduced above it is also advantageous to be able to extend the deadbolt within the defined recess of the doorframe as far as possible as this will improve the secured engagement of the door to be prevented from being opened without authorisation.

It would also be advantageous to provide a bolt assembly for a deadbolt lock arrangement wherein the individual components and structural feature may be assembled and contained within the main housing body conveniently for operational exchange but also in general user handling during installation and the like.

It is therefore an object of this invention to provide a new and improved bolt assembly for a deadbolt lock arrangement that has hitherto been previously available.

Further objects and advantages of the invention will become apparent from a complete reading of the following specification.

### SUMMARY OF THE INVENTION

In one form of the invention there is provided a deadbolt lock arrangement, said arrangement including;

a main housing body mountable within a bore hole along an edge of a door wherein said door is to be deadbolt lockable;

a drivable cam mounted within said main housing body, wherein said drivable cam is in rotational engagement with a follower wheel mounted within said main housing body;

a bolt connecting arm pivotally supported at a first end to a bolt slidably supported within the main housing body and wherein the bolt connecting arm at an opposing second end is pivotally connected to a first end of a follower wheel connecting arm, wherein a second end of the follower wheel connecting arm is connected to said follower wheel;

wherein rotation of said drive cam in a first direction translates to rotational movement of said follower wheel in a first direction, said rotational movement of said follower wheel in the first direction translates to an extended positioning of said follower wheel connecting arm so as to extend said bolt connecting arm to an extended position;

whereby when the bolt connecting arm is in the extended position said bolt is slidably driven to a protruded position out from the main housing body into a lock configuration.

In preference rotation of said drive cam in a second direction translates to rotational movement of said follower wheel in a second direction, said rotational movement of said follower wheel in the second direction translates to a retracted positioning of said follower wheel connecting arm so as to retract said bolt connecting arm to a retracted position; whereby when the bolt connecting arm is in the retracted position the bolt is slidably driven to a retracted position within the main housing body for an unlocked configuration.

In preference the drivable cam and the follower wheel communicate by a gearing arrangement.

In preference the gearing arrangement includes a section of Teeth/gears on each of the peripheral edges of the respective drivable cam and follower wheel wherein said sections of Teeth/gears of each of the drivable cam and follower wheel are in contact engagement with each other.

In preference the drivable cam is generally circular/cylindrical with an irregular protruding nose along a section of the circumferential peripheral edge.

In preference the irregular protruding nose section of the generally circular/cylindrical drivable cam includes the section of Teeth/gears of said drivable cam.

In preference the drivable cam includes a degree of resiliency when mounted within the main housing body.

In preference the degree of resiliency of the drivable cam within the main housing body is controlled by a resilient wedge, clip or spring.

In preference the resilient wedge, clip or spring engages the circumferential peripheral edge of the generally cylindrical shaped drivable cam on a substantially opposing side or section to the irregular protruding nose along the section of the peripheral edge of said generally cylindrical shaped drivable cam.

In preference the circumferential peripheral edge of the generally cylindrical shaped drivable cam includes a configured contact area with said resilient wedge, clip or spring.

In preference the configured contact area along the circumferential peripheral edge of the generally cylindrical shaped drivable cam with said resilient wedge, clip or spring includes a first flattened or linear contoured section wherein the first flattened or linear contoured section is connected through an apex to a second flattened or linear contoured section of the contact area.

In preference said first flattened or linear contoured section of the contact area with said resilient wedge, clip or spring occurs when the bolt connecting arm is in the retracted position and the bolt is slidably driven to the retracted position within the main housing body for the unlocked configuration and wherein contact of said second flattened or linear contoured section with said resilient wedge, clip or spring occurs when the bolt connecting arm is in the extended position and said bolt is slidably driven to the protruded position out from the main housing body into the lock configuration.

Advantageously the use of the resilient clip, wedge and/or spring allows the drivable cam to be comfortably and with generally biased assistance to be rotatable between either of the locked and/or unlocked configuration through the use of two defined linear sections along the circumferential peripheral edge of the drivable cam.

In preference the follower wheel connecting arm is mounted to the follower wheel.

As the follower wheel connecting arm is mounted in this preferred embodiment directly to the follower wheel it almost acts as a direct tab extension from the follower wheel so any rotation of the follower wheel will then see the simultaneous rotation of the follower wheel connecting arm which is pivotally connected to the bolt connecting arm that slidably controls the extension and retraction of the bolt from and within the main housing body.

In preference the bolt at a bolt base end includes a receival slot in which the second end of the bolt connecting arm is able to be received to be pivotally supported therein at the base of the bolt.

The unique arrangement between the drivable cam, follower wheel and each of the respective bolt connecting arm and follower wheel connecting arm is able to translate rotational movement of the drivable cam ultimately into the lateral extension and/or retraction of the bolt slidably within and protruding out from the main housing body as required between the locked and unlocked configurations.

In preference the main housing body includes a face plate wherein screws receivable within apertures provided by the face plate are adapted to mount the bolt assembly within a bore hole along the edge of the door.

In preference the main housing body further includes a cylindrical enclosure adapted to slidably enclose and contain therein said bolt.

In preference the cylindrical enclosure at one end includes a extended tabs or plates where each plate or tab includes apertures which are configured to overlap the apertures of the face plate when the bolt assembly is to be mounted within the bore hole along the edge of the door.

In preference the main housing body further includes a side plate and a substantially L shaped side and end member wherein when assembled the side plate is engageable and fastenable to the L shaped side and end member.

In preference the L shaped side and end member and the side plate are engageable at the opposing distal end of the cylindrical enclosure to wherein the cylindrical enclosure engages the face plate.

In preference the resilient clip, wedge and/or spring is positioned and supported substantially at the rear of the main housing body.

In order now to describe the invention in greater detail a series of preferred embodiments will be presented with the assistance of the following illustrations and accompanying text.

### BRIEF DESCRIPTION OF THE DRAWINGS

FIG. 1 is a generally front perspective view of the bolt assembly for a deadbolt lock arrangement looking from one side in a preferred embodiment of the invention.

FIG. 2 is a generally front perspective view of the bolt assembly of FIG. 1 viewing from the other side to that represented in FIG. 1.

FIG. 3 is a perspective view of the bolt assembly in a preferred embodiment of the invention looking from a rear perspective.

FIG. 4 is an exploded view of the bolt assembly in a preferred embodiment of the invention.

FIG. 5 is a part cross-sectional view of the bolt assembly in a preferred embodiment of the invention when the bolt assembly is in a locked configuration.

FIGS. 6a, 6b and 6c provide schematic representations of the operation of the bolt assembly from a retracted, mid and unlocked configuration in a preferred embodiment of the invention.

### DETAILED DESCRIPTION OF THE DRAWINGS

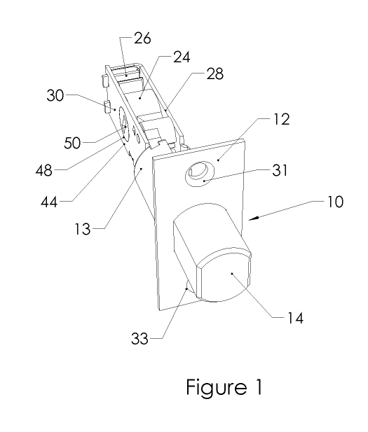

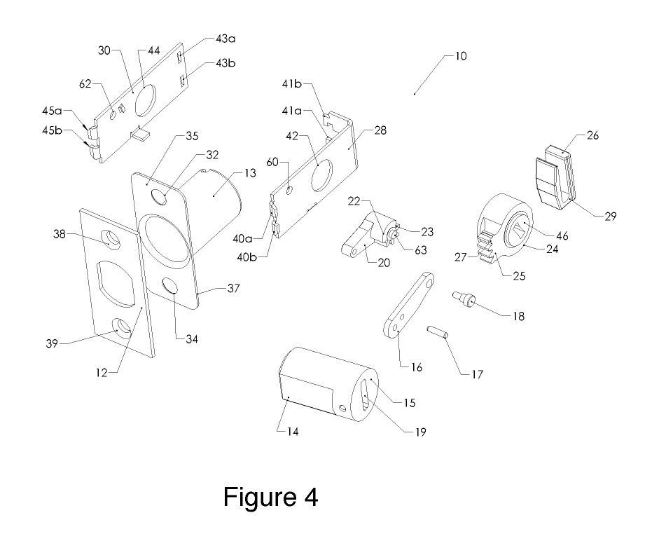

The bolt assembly as seen in the assembled configurations shown in FIGS. 1, 2 and 3 and by referencing its individual features as best seen in the exploded view of FIG. 4, includes a face plate (12) a cylindrical enclosure (13) for the bolt (14). The bolt connecting arm (16) at one end is received within a slot (19) at the base (15) of the bolt (14) to be pivotally supported there within slot (19) by reference of the pivot pin (17).

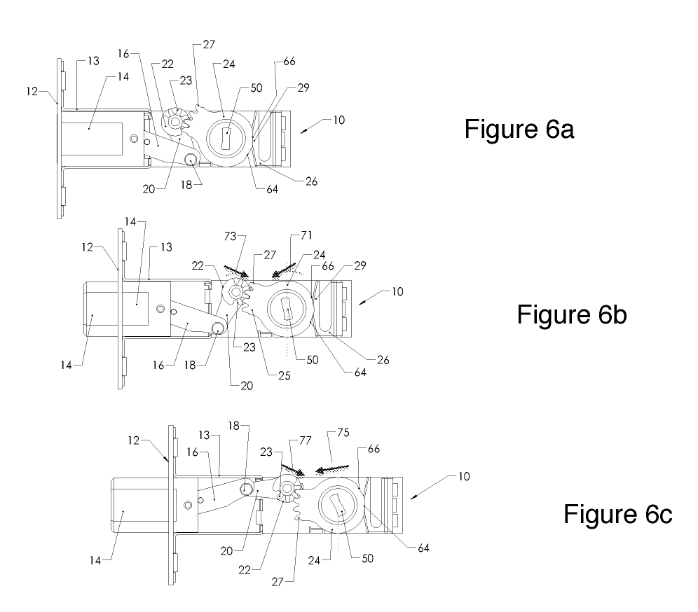

The bolt connecting arm (16) is pivotally connected through pin (18) to the follower wheel connecting arm (20) which is mounted to the follower wheel (22). The drivable cam (24) generally cylindrical in configuration includes an irregular protruding nose (25) at the circumferential peripheral edge which includes a series of Teeth/gears (27) which as will be discussed in greater detail when referencing FIGS. 6a, 6b and 6c are mounted within the bolt assembly (10) so as to engage the teeth/gears (23) of the follower wheel (22).

Also included as part of the bolt assembly (10) of which components will be discussed in greater detail hereafter is the resilient clip or spring (26), the L shaped side and end member (28) and the side plate (30).

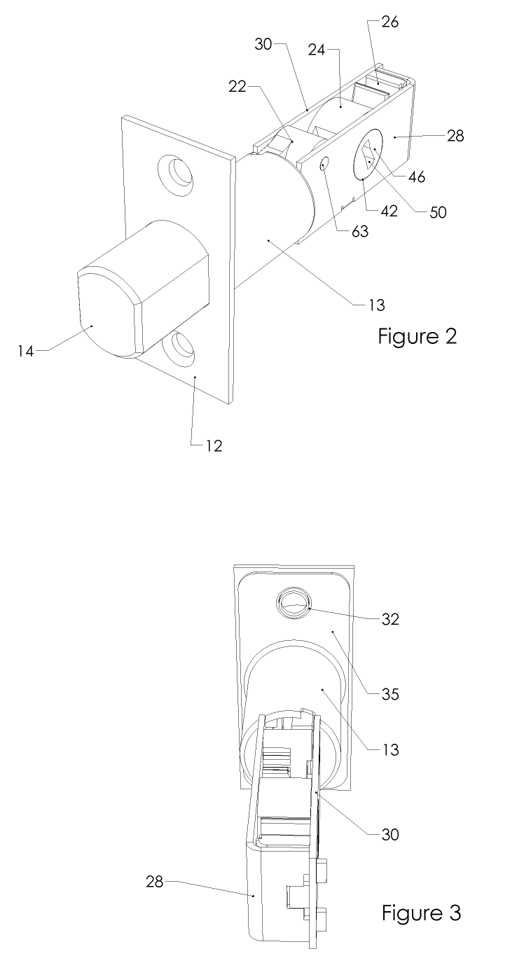

For the most part the main body housing of the bolt assembly (10) includes the cylinder enclosure (13) which as best seen in FIG. 2 has tab extension plates (35) and (37) that extend out from opposing sides at each end of the cylindrical enclosure (13) which provide for apertures (32) and (34) which when the bolt assembly (10) is in the mounting position again as best seen in FIG. 3 the holes (38) and (39) of the face plate (12) align up with the holes (32) and (34) of the tab extensions (35) and (37) extending or shouldering off the cylindrical enclosure (13).

The main housing body also includes the L shaped side and end member (28) which has tab extensions (40a) and (40b) which are adapted to engage the cylinder enclosure (13) for mated engagement.

At the opposing end of the L shaped side and end member (28) is a further pair of tab extensions (41a) and (41b) which are adapted to engage corresponding slots (43a) and (43b) of the side plate (30).

Side plate (30) further includes tab extensions (45a) and (45b) at one end and as best seen in the assembled configurations of FIGS. 1, 2 and 3 the main housing body is able to be assemble between the cylindrical enclosure (13), L shaped side and end member (28) and the side plate (30) without any additional independent fasteners and the like.

The L shaped side and end member (28) includes aperture (42) and when the L shaped side and end member (28) is engaged with the side plate (30) the aperture (42) aligns with the corresponding aperture (44) on the side plate (30).

These apertures (42) and (44) provide a mount for the drivable cam (24) within the main housing body when assembled.

The drivable cam (24) includes a raised column (46) and (48) on each side of the drivable cam (24).

There is a continuous slot (50) that runs through the drivable cam (24) and again as will be discussed in greater detail hereafter engagement with that slot (50) by a spindle or the like and the rotation thereof will instigate the drivable rotation movement of the drivable cam (24).

The raised columns (46) and (48) on the respective opposing sides of the drivable cam (24) are able to rest within the corresponding apertures (42) and (44) of the respective L shaped end and side member (28) and side plate (30) so that the drivable cam as best seen in FIGS. 1, 2 and 3 is mountable within the main housing body of the bolt assembly (10).

Hole (60) on the L shaped end and side member (28) along with hole (62) on the side plate (30) when the L shaped side and end plate (28) and side plate (30) are assembled together allows the holes (60) and (62) to align up so that a pivot pin (63) extending out from the corresponding sides of the follower wheel (22) can be pivotally supported in the holes (60) and (62) when the main housing body of the bolt assembly (10) is assembled together.

Mounted to the follower wheel (22) is the follower wheel connecting arm which through pivot pin (18) is connected to the bolt connecting arm (16) which as introduced above the bolt connecting arm (16) is received into a receival slot (19) at the base (15) of the bolt (14) to be supported by the pivot pin (17).

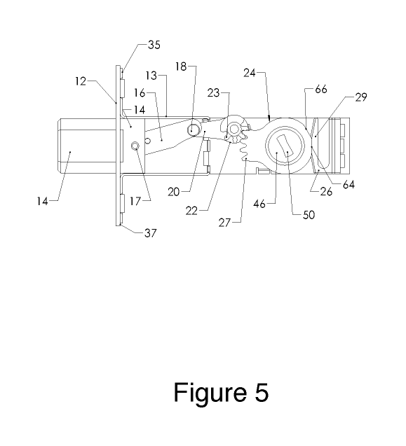

The bolt (14) is slidably retractable into the cylindrical enclosure (13) and as seen in FIG. 5 is also extendable out from the face plate (12).

The drivable cam (24) along the circumferential side or edge of the generally cylindrically shaped drivable cam (24) includes two substantially linear sections (64) and (66) which are adapted to engage the contact leaf (29) of the resilient spring or clip (26).

The purpose of the lineated sections (64) and (66) along the circumferential edge of the generally cylindrically shaped drive cam (24) will be discussed in greater detail when referencing FIGS. 6a, 6b and 6c.

Before the operation of the bolt assembly (10) is discussed in greater detail when referencing FIGS. 6a, 6b and 6c it can be inferred from the representations shown in FIG. 1 through to FIG. 5 that the bolt assembly is configured in a convenient secured construction wherein the individual features can be housed and assembled together without difficulty.

If access is required into the bolt assembly (10) the side plate (30) can be withdrawn.

Once the side plate (30) is withdrawn, unlike most other conventional bolt assembly arrangements the mounted components and parts can all still remain generally secured one with respect to the other rather than all falling apart where then complete re-assembly will be a requirement.

For example as the bolt (14) is slidably secured within its own cylindrical housing (13) as part of the main housing body, once the side plate (30) is withdrawn the bolt still does not automatically dislodge and become separated from the remaining connected components.

FIG. 6a shows the bolt assembly in an unlocked configuration wherein the bolt (14) is in a retracted position within the cylindrical enclosure (13) of the main housing body of the bolt assembly (10).

As can be seen the follower wheel connecting arm (20) is also in the retracted position and as the follower wheel connecting arm (20) is in the retracted position and it is pivotally connected to the bolt connecting arm (16) through the pivot pin (18) when the follower wheel connecting arm (20) is in the retracted position this then pulls back the bolt connecting arm (16) so as to slidably position the bolt (14) within the cylindrical enclosure (13).

The circumferential edge profile of the drivable cam (24) has the lineated section (66) abutting up against the resilient spring (26) thereby providing a resilient mount for the drivable cam (26) when the bolt assembly (10) is in the unlocked and/or retracted position.

FIG. 6b is representative of the transition between the unlocked to locked configuration.

As shown by way of arrow (71) if the drivable cam (24) is rotated normally through the use of a spindle (not shown) which passes through the slot (50) of the drivable cam (24) as part of the locking mechanism associated with the deadbolt lock arrangement to which the bolt assembly (10) is used with, this rotational movement of the drivable cam (24) translates to rotational movement of the follower wheel (22) as the teeth (23) of the follower wheel (22) are engaged with the corresponding teeth/gears (27) of the drivable cam (24).

As the follower wheel connecting arm (20) is mounted to the drivable wheel (22), when the drivable wheel (22) is rotated in the first direction as referenced by the arrow (73) this then starts to rotatably move the follower wheel connecting arm (20) from its retracted position as shown in FIG. 6a to the beginning of the extended configuration as seen in FIG. 6b.

As the follower wheel connecting arm (20) is pivotally connected to the bolt connecting arm (16) by the pivot pin (18) this movement of the follower wheel connecting arm (20) away from the retracted position due to the rotation of the follower wheel (22) forces the bolt connecting arm (16) to also move generally move towards an extended position thereby slidably acting upon the bolt (14) to commence the protruding of the bolt (14) out from the face plate (12) of the bolt assembly (10).

FIG. 6c shows the bolt (14) protruding out from the face plate (12) of the bolt assembly (10) which is consistent to the locked or extended position.

The further rotation of the drivable cam (24) in the first direction shown by way of arrow (75) then sees further translational rotational movement of the follower wheel (22) due to the respective engagement of the corresponding gears or teeth (23) and (27) respectively.

The further rotation of the follower wheel (22) due to the fact that the follower wheel connecting arm (20) is mounted thereto the follower wheel (22) then forces the bolt connecting arm (16) to act upon the bolt (14) slidably protruding it out from the cylindrical enclosure (13) beyond the face plate (12) of the bolt assembly (10) to provide the locked or extended configuration.

In order to return the locked or extended configuration shown in FIG. 6c to the unlocked configuration in FIG. 6c, all that is required is the rotation of the drivable cam in the opposite direction and this then translates to appropriate movement of the follower wheel (22) such that the follower wheel connecting arm (20) is able to return to its retracted position and as the follower wheel connecting arm (20) returns to the retracted position it then pulls the bolt connecting arm (16) back into a retracted position which results in the bolt (14) returning within the cylindrical enclosure (13) of the bolt assembly (10).

1. A bolt assembly for a deadbolt lock arrangement, said arrangement including;
a main housing body mountable within a bore hole along an edge of a door wherein said door is to be deadbolt lockable;
a drivable cam mounted within said main housing body, wherein said drivable cam is in rotational engagement with a follower wheel mounted within said main housing body;
a bolt connecting arm pivotally supported at a first end to a bolt slidably supported within the main housing body and wherein the bolt connecting arm at an opposing second end is pivotally connected to a first end of a follower wheel connecting arm, wherein a second end of the follower wheel connecting arm is connected to said follower wheel;
wherein rotation of said drive cam in a first direction translates to rotational movement of said follower wheel in a first direction, said rotational movement of said follower wheel in the first direction translates to an extended positioning of said follower wheel connecting arm so as to extend said bolt connecting arm to an extended position;
whereby when the bolt connecting arm is in the extended position said bolt is slidably driven to a protruded position out from the main housing body into a lock configuration.

2. The bolt assembly of claim 1 wherein rotation of said drive cam in a second direction translates to rotational movement of said follower wheel in a second direction, said rotational movement of said follower wheel in the second direction translates to a retracted positioning of said follower wheel connecting arm so as to retract said bolt connecting arm to a retracted position; whereby when the bolt connecting arm is in the retracted position the bolt is slidably driven to a retracted position within the main housing body for an unlocked configuration.

3. The bolt assembly of claim 1 wherein the drivable cam and the follower wheel rotational engagement is a gearing engagement arrangement.

4. The bolt assembly of claim 3 wherein the gearing engagement arrangement includes a section of teeth on each of peripheral edges of the respective drivable cam and follower wheel that contact with each other.

5. The bolt assembly of claim 1 wherein the drivable cam is of a generally cylindrical shape including an irregular protruding nose along a section of a peripheral edge of said generally cylindrical shaped drivable cam.

6. The bolt assembly of claim 5 wherein the irregular protruding nose along the section of the peripheral edge of said generally cylindrical shaped drivable cam includes said section of teeth of said drivable cam in contact with said section of teeth on the peripheral edge of said follower wheel.

7. The bolt assembly of claim 6 wherein the drivable cam includes a degree of resiliency when mounted within the main housing body.

8. The bolt assembly of claim 7 wherein the degree of resiliency of the drivable cam within the main housing body is controlled by a resilient wedge, clip or spring mounted within the main housing body.

9. The bolt assembly of claim 8 wherein the resilient wedge, clip or spring engages the circumferential peripheral edge of the generally cylindrical shaped drivable cam on a substantially opposing side or section to the irregular protruding nose along the section of the peripheral edge of said generally cylindrical shaped drivable cam.

10. The bolt assembly of claim 9 wherein the circumferential peripheral edge of the generally cylindrical shaped drivable cam includes a configured contact area with said resilient wedge, clip or spring.

11. The bolt assembly of claim 10 wherein the configured contact area along the circumferential peripheral edge of the generally cylindrical shaped drivable cam with said resilient wedge, clip or spring includes a first flattened or linear contoured section wherein the first flattened or linear contoured section is connected through an apex to a second flattened or linear contoured section of the contact area.

12. The bolt assembly of claim 11 wherein said first flattened or linear contoured section of the contact area with said resilient wedge, clip or spring occurs when the bolt connecting arm is in the retracted position and the bolt is slidably driven to the retracted position within the main housing body for the unlocked configuration and wherein contact of said second flattened or linear contoured section with said resilient wedge, clip or spring occurs when the bolt connecting arm is in the extended position and said bolt is slidably driven to the protruded position out from the main housing body into the lock configuration.

13. The bolt assembly of claim 1 wherein the bolt at a bolt base end includes a slot, said slot is adapted to receive the first end of the bolt connecting arm to pivotally supported the first end of the bolt connecting arm therein the slot at the base of the bolt.

14. The bolt assembly of claim 1 wherein the main housing body further includes a cylindrical enclosure adapted to slidably enclose said bolt.

15. The bolt assembly of claim 14 wherein the cylindrical enclosure at one end includes an extended tab or tabs.

16. The bolt assembly of claim 1 wherein the main housing body further includes a side plate and a substantially L shaped side and end member wherein when assembled the side plate is engageable and fastenable to the L shaped side and end member through a tab extension and corresponding slot arrangement between the side plate and the substantially L shaped side and end member.
